(19) United States
(12) Patent Application Publication
(10) Pub. No.: US 2005/0253974 A1
(43) Pub. Date: Nov. 17, 2005

(54) Pixellated display and imaging devices

(76) Inventor: Joshua Elliott, Wellington (NZ)

Correspondence Address: Unisys Corporation, Unisys Way, M/S E8-114, Blue Bell, PA, 19424-0001, US

(21) Appl. No.: 10/524,618

(22) PCT Filed:
(86) PCT No.: PCT/NZ02/00130

(51) Int. Cl. G02F 1/13

(52) U.S. Cl. 349/2

(57) ABSTRACT

The invention provides an optical layer (13) having an array of light guides (9), the light guides being arranged such that when the optical layer is superimposed on an array of pixel devices (10) arranged in a first lattice pattern (1-8), the light guides optically guide light from the pixel devices into a second lattice pattern (1′-8′).

The invention also provides a display device for generating a pixellated image, the device having an array of pixel devices (31) for generating the pixellated image, wherein each pixel (41,43) in the image partially overlaps (44) with at least one other pixel.

### FIELD OF THE INVENTION

The present invention relates to various improvements in connection with pixellated display devices (that is, devices that display an image to a user) and pixellated imaging devices (that is, devices that acquire an image for instance from a scene or by scanning a transparency).

### BACKGROUND ART

Many conventional display devices use a screen with a square lattice pattern of pixel devices 50 as shown in FIG. 16. A problem with square lattice patterns is that images can be subject to aliasing. Image distortion due to aliasing is apparent in the diagonal line of dark pixels shown in FIG. 16.

Similar aliasing problems exist in conventional imaging devices.

One approach to this problem is to use a non-square matrix of pixel devices 51 as shown in FIG. 17. This results in images with different distortion characteristics, as can be seen by comparing the diagonal lines in FIGS. 16 and 17.

Various other non-square lattice patterns (including hexagonal) are described in U.S. Pat. No. 5,311,337.

A problem with these non-square patterns is that they require the manufacture of a new screen, with the pixel devices arranged in the desired pattern.

Another problem is that image distortion will still be present, even in hexagonal pixel patterns.

### DISCLOSURE OF THE INVENTION

A first aspect of the invention provides an optical layer having an array of light guides, each light guide having a first end and a second end, the first ends being arranged in a first lattice pattern, and the second ends being arranged in a second lattice pattern.

A second aspect of the invention provides a display screen including an array of pixel devices arranged in a first lattice pattern; and an optical layer having an array of light guides, each light guide having a input end and an output end, the output ends being arranged in a second lattice pattern, and the input ends being arranged in the first lattice pattern and directed towards the pixel devices whereby the light guides guide light from the pixel devices from their input ends to their output ends.

A third aspect of the invention provides an imaging screen having an array of light sensitive pixel devices arranged in a first lattice pattern; and an optical layer having an array of light guides, each light guide having a input end and an output end, the input ends being arranged in a second lattice pattern, and the output ends being arranged in the first lattice pattern and directed towards the pixel devices whereby the light guides guide light from their input ends to their output ends and onto the pixel devices.

The first aspect of the invention provides an optical layer which can be superimposed on a conventional screen to convert the screen into a different lattice pattern. The optical layer may be removable, to enable the layer to be transferred onto a different screen.

The second aspect provides a display screen in combination with the optical layer. The third aspect provides an imaging screen in combination with the optical layer.

The light guides preferably have light reflecting walls which each guide light from a respective pixel device. These walls may be internal facets, may be formed from a different material to the rest of the optical layer, or may be formed by chemically treating the optical layer (for example by doping).

Typically at least some of the light reflecting walls are non-parallel.

The optical layer may convert between any two lattice patterns. For instance it may convert between the lattice patterns shown in FIGS. 16 and 17.

In a preferred embodiment the second lattice pattern is hexagonal. This enables a hexagonally sampled image data set to be used. Hexagonally sampled data sets have various advantages due to their high rotational symmetry. For instance it is more computationally efficient to perform image rotations, enlargements or reductions, compared to data sets sampled on the basis of a square sampling pattern.

There may be a gap between the pixel devices and the optical layer. However preferably the optical layer physically engages the pixel devices.

The optical layer is particularly useful in a hand-held, portable display device such as a Personal Digital Assistant (PDA); or a cellular, WAP or 3G telephone.

Typically the screen is provided in a display device having a screen drive for driving the pixel devices. The display device may receive data compatible with the second lattice pattern. In this case, no data resampling is required. However in a preferred example the display device includes a resampler programmed to:
a) receive image data in a format compatible with the first lattice pattern,
b) resample the image data into a format compatible with the second lattice pattern, and
c) output the resampled image data to the screen drive.

The device may be provided with means for manipulating the image data, which may be provided on a graphics card.

A fourth aspect of the invention provides a display device for generating a pixellated image, the device having an array of pixel devices for generating the pixellated image, wherein each pixel in the image partially overlaps with at least one other pixel.

The partially overlapping pixels form an image having different distortion characteristics when compared with conventional non-overlapping pixellated images.

The pixel devices may be phosphor dots on a cathode ray tube or gas chambers in a plasma display. Alternatively the device may have a light source and the pixel devices modulate light from the light source (an example being a backlit LCD screen).

The pixel devices may overlap themselves. Alternatively the pixel devices may be non-overlapping, and pixel overlap is provided by projecting light from the pixel devices onto a display surface such that the light partially overlaps at the display surface. In this case, an array of lenses may be provided, each lens receiving light from a respective one of the pixel devices.

### BRIEF DESCRIPTION OF THE DRAWINGS

Embodiments of the invention will now be described with reference to the accompanying Figures, in which:

FIG. 1 is a schematic plan view of eight square pixels overlaid with an optical layer of eight hexagonal light guides;

FIG. 2 is a cross section along line A-A in FIG. 1;

FIG. 3 is a cross section along the line B-B in FIG. 1;

FIG. 4 is a cross section along line C-C in FIG. 1;

FIG. 5 is a schematic view of the screen of FIG. 1, with exaggerated perspective;

FIG. 6 is a schematic view of a display device incorporating the screen of FIGS. 1-5;

FIG. 7 is a plan view of six square pixels showing their relative image densities;

FIG. 8 shows a single hexagonal light guide overlaid in the centre of the six pixels;

FIG. 9 is an illustration of the density of one of the square pixels following transformation;

FIG. 10 is a schematic plan view of eight square pixels overlaid with an optical layer of eight hexagonal light guides, showing an alternative configuration to FIG. 1;

FIG. 11 is a schematic view of an imaging device incorporating an optical layer according to the invention;

FIG. 12 is a schematic plan view of part of the optical layer and CCD screen of FIG. 11;

FIG. 13 is a schematic view of a projection display device;

FIG. 14 is a side view of the LCD screen taken from the right of FIG. 13 showing the individual lenses;

FIG. 15 is a side view of the overlapping illuminated areas on the display surface of FIG. 13;

FIG. 16 shows a diagonal line on a conventional square lattice pixel screen; and

FIG. 17 shows a diagonal line on a non-square lattice pixel screen.

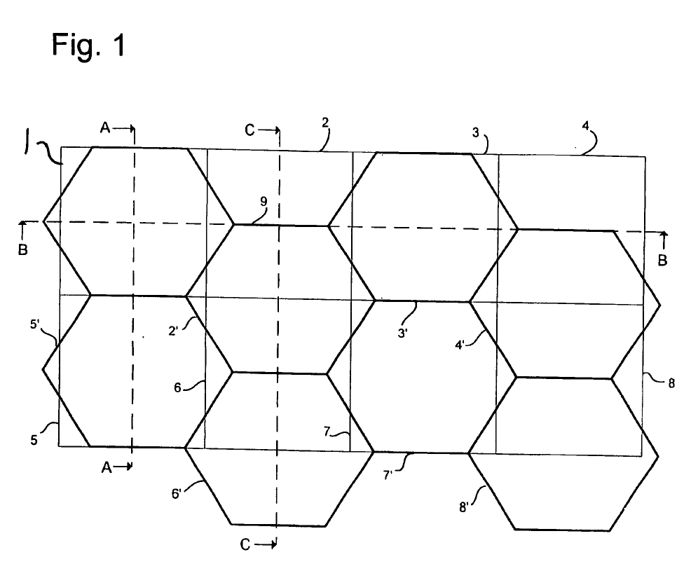

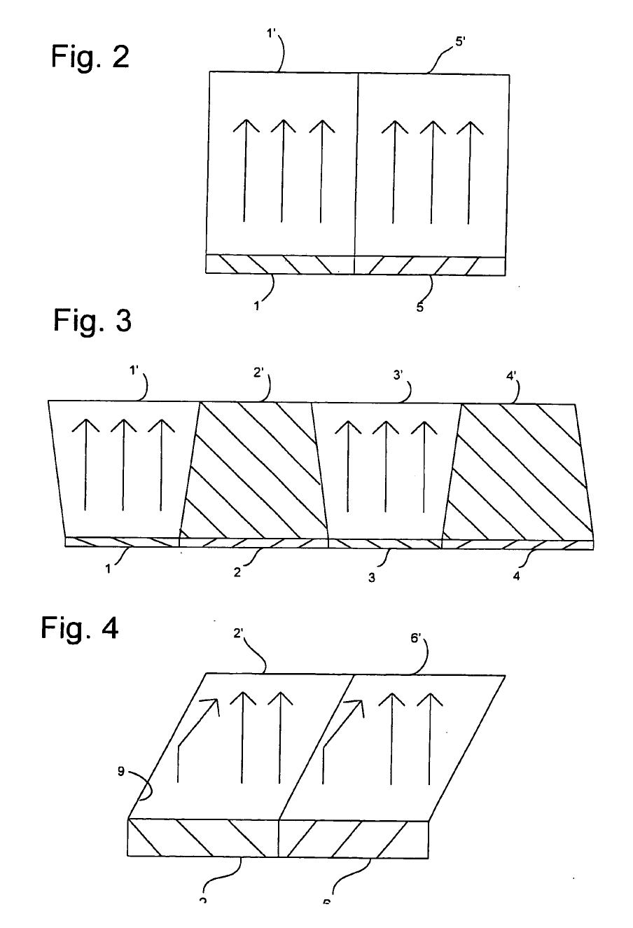

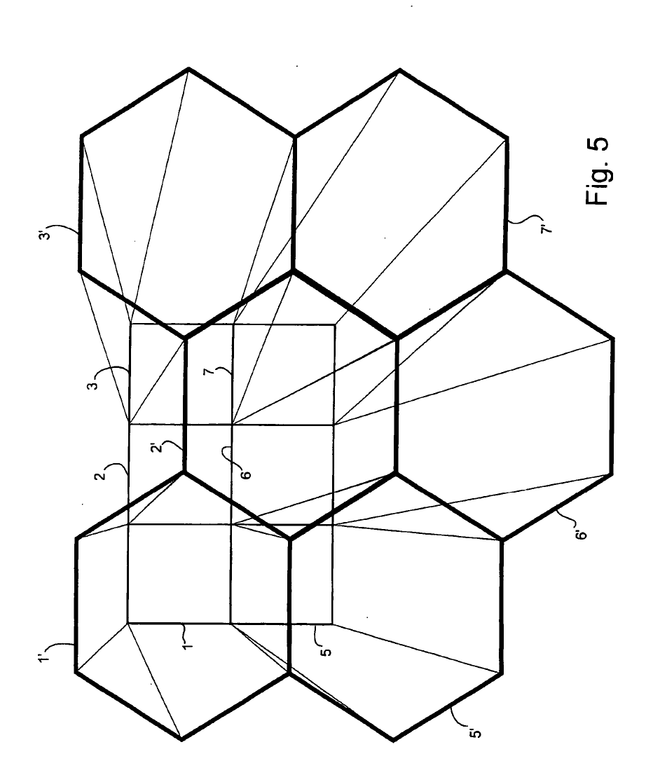

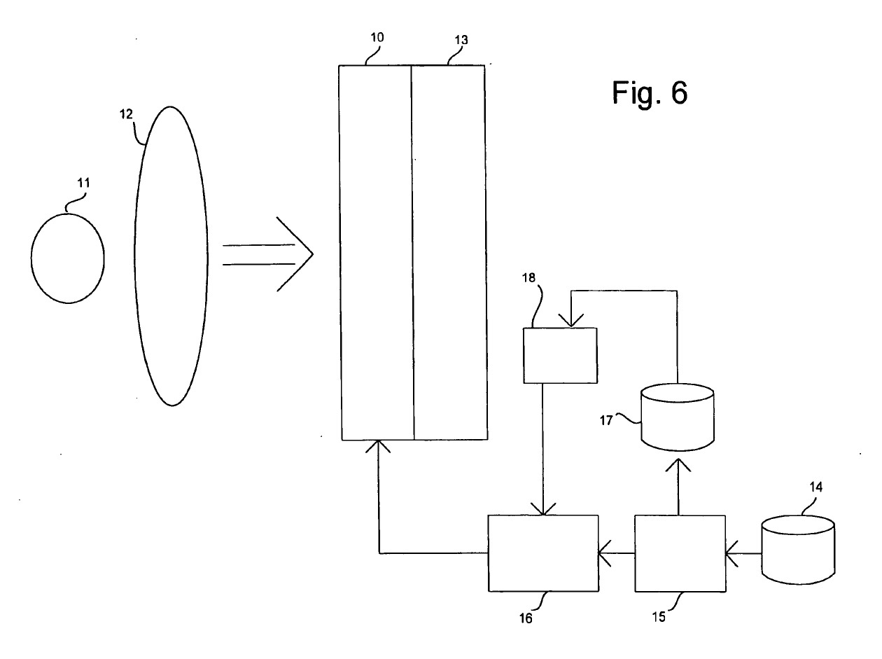

Referring to FIGS. 1 and 6, a conventional LCD screen 10 is backlit by a light source 11 and lens 12. Optionally a second lens (not shown) may be provided in front of the screen, or may replace the lens 12. The LCD screen is formed from a square array of LCD pixels. Eight of the pixels forming the screen 10 are shown in FIG. 1, numbered 1-8. The screen 10 is overlaid with an optical layer 13 which converts the square array of the screen 10 into a hexagonal array. The structure of the optical layer 13 is shown most clearly in FIGS. 2-5. The optical layer is formed from a transparent material divided into a “honeycomb” structure by a matrix of reflective, non-transparent walls. The reflective walls define an array of light guides which have square input ends and guide the light from the square pixels 1-8 into respective hexagonal output ends (or pixels) 1′-8′ as shown most clearly in the exaggerated perspective view of FIG. 5. The reflective action can also be seen in FIG. 4, in which light from square pixel 2 is shown being reflected by angled reflective wall 9 so that the light is emitted from the hexagonal output end 2′.

A variety of different methods of manufacturing the optical layer 13 can be used.

In a first two-step manufacturing example, a first liquid polymer is injected into a two part mould to form the matrix of reflecting walls. After the polymer sets, the mould is removed and a second liquid polymer poured in to fill the cells bounded by the matrix of walls.

In a second two-step manufacturing example, the walls are formed by etching material away from a layer of transparent material. A liquid polymer is then poured in to fill the cells bounded by the matrix of walls.

In a one-step manufacturing example, a continuous layer of transparent material is doped to form the matrix of reflecting walls.

The LCD screen 10 is driven by a set of electronics shown in FIG. 6. A memory 14 contains a set of density values which have been obtained by sampling an original image (such as a transparency) using a square lattice sampling array. The density values from memory 14 are input to a resampling processor 15 which performs a resampling algorithm to convert the density values into hexagonal density values, to account for the presence of the optical layer 13. The resampled density values are then received by an LCD screen driver 16 which controls the LCD screen 10 accordingly.

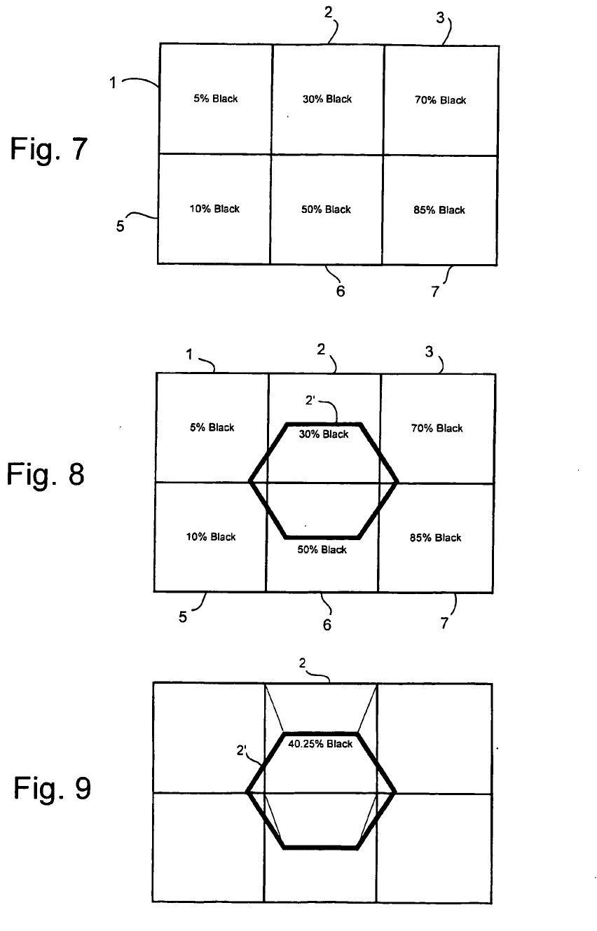

The resampling algorithm performed by processor 15 is illustrated in FIGS. 7-9. The six density values in memory 14 for the six square pixels 1-3 and 5-7 shown in FIG. 7 are 5%, 30%, 70%, 10%, 50% and 85% respectively. The hexagonal pixel 2′ shown in FIGS. 8 and 9 overlaps 45% of pixels 2, 6 and 2.5% of square pixels 1, 3, 5 and 7.

Therefore the algorithm calculates the resampled pixel density D as:

$$\begin{matrix}D = ( 30 \% + 50 \% ) * 0.45 + ( 5 \% + 70 \% + 10 \% + 85 \% ) * 0.025 \\ = 40.25 \%\end{matrix}$$

The resampled pixel density value of 40.25% is shown in FIG. 9. Similar calculations are used to resample the density values for the other pixels.

Optionally the resampled density values may be stored in a memory 17 and manipulated by graphics processor 18. The graphics processor 18 may perform a variety of manipulation algorithms such as rendering, rotation, translation, enlargement or reduction.

The processors 15,18 and memory 17 may be provided in a graphics card which is inserted into a conventional display device.

In an alternative embodiment (not shown), the device may receive hexagonally sampled data. In this case, no resampling processor 15 or store 17 will be necessary to resample or store the density values.

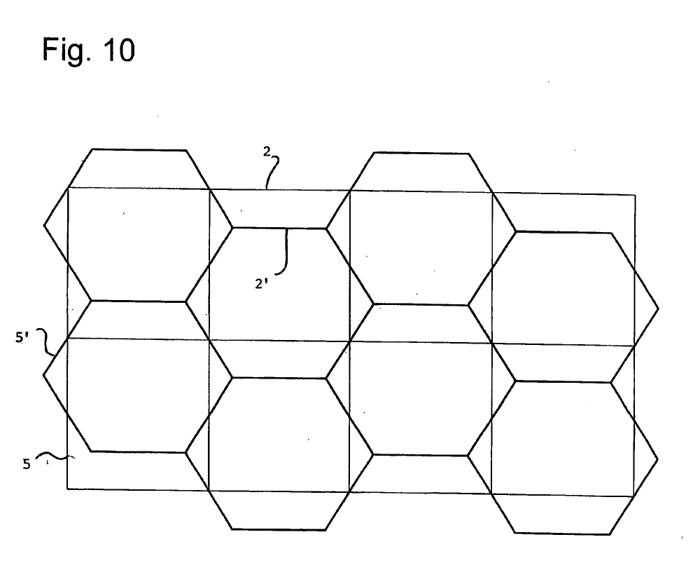

In the plan view of FIG. 1, it can be seen that there is greater overlap between square pixel 5 and hexagonal pixel 5′, than between square pixel 2 and hexagonal pixel 2′. The plan view of FIG. 10 illustrates an alternative arrangement which provides more equal degrees of overlap. The same reference numerals are used in FIG. 10 for equivalent features from FIG. 1.

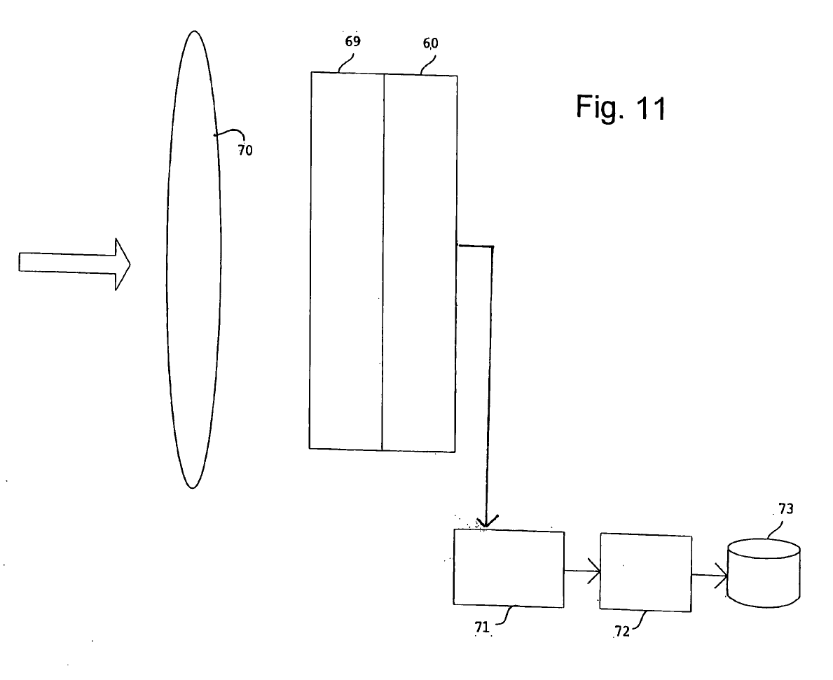

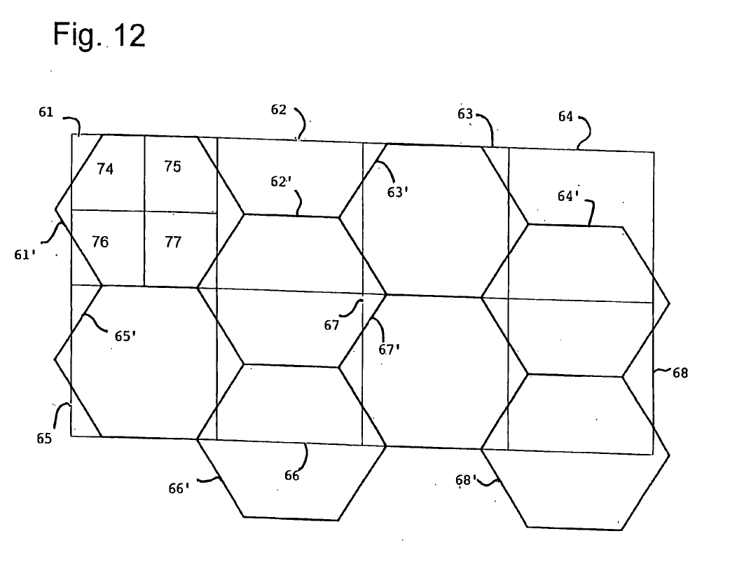

FIG. 11 shows an embodiment of an imaging device according to the invention. A charge-coupled device (CCD) 60 comprises a square array of light sensitive pixels 61-68 shown in FIG. 12. The pixels 61-68 are formed on a silicon wafer. The silicon wafer is integrally formed with an optical layer 69 of similar form to the optical layer 13 of FIG. 6, which defines an array of cells with hexagonal input ends 61′-68′ and square output ends overlaying the pixels 61-68. The optical layer 69 can be formed in the silicon wafer by a doping method. Light is focused by a lens 70 onto the layer 69 and is guided onto the CCD pixels 61-68 which generate image signals which are output to an output interface 71.

The output interface 71 outputs the image data to a resampling processor 72 which resamples from hexagonal to square image space (ie performs the inverse of the algorithm performed by resampler 15 shown in FIG. 6) and outputs the resampled image data to store 73. The resampling processor 72 can also generate a set of sub-pixel values by interpolation. For example, referring to FIG. 12, four sub-pixel values are generated for sub-pixels 74-77 within pixel 61.

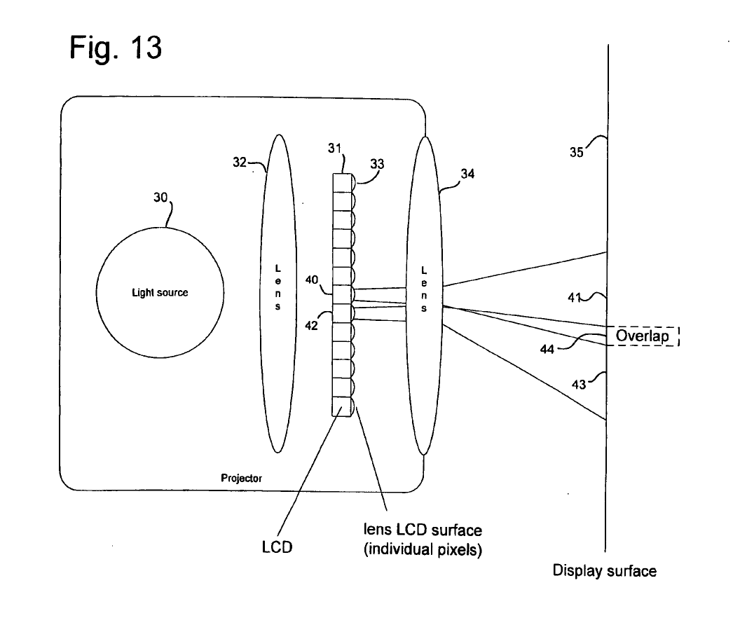

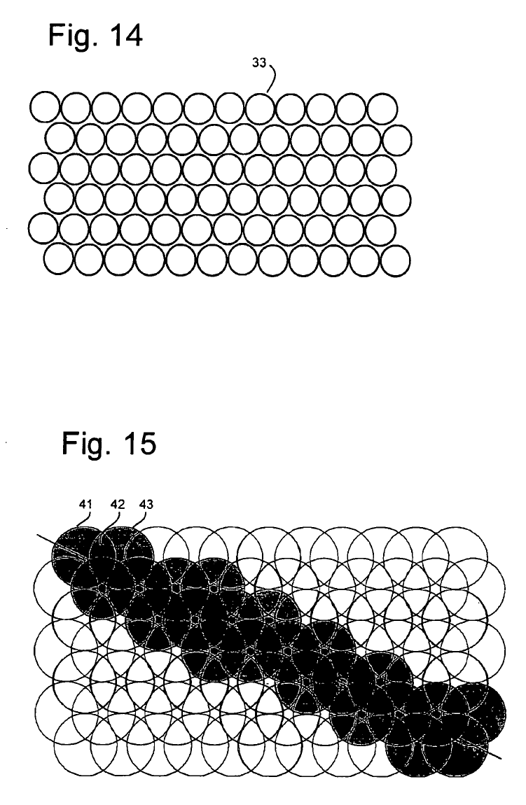

Referring to FIG. 13, a projection system comprises a light source 30 which illuminates an LCD screen 31 via a lens 32. The LCD screen 31 has an array of hexagonally arranged pixels, each of which is overlaid with a respective lens 33, shown in FIG. 14. The light from the lenses 33 diverges slightly and is imaged by a second lens 34 onto a display surface 35. The arrangement is such that the light from the individual pixels overlaps slightly at the display surface. Thus for example the light from pixel 40 is projected onto an area 41 and the light from pixel 42 is projected onto an area 43, with a small area of overlap 44. This is shown clearly in the view of FIG. 15 in which it can be seen that each pixel partially overlaps with six other pixels. A diagonal line is also shown in FIG. 15.

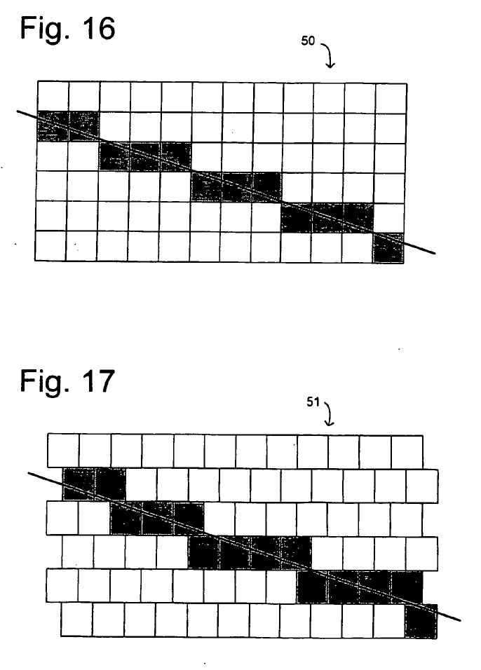

The partially overlapping pixel arrangement shown in FIG. 15 provides an alternative solution to the aliasing problem illustrated in FIGS. 16 and 17. That is, the high resolution diagonal lines shown in FIGS. 16 and 17 have different aliasing distortion properties to the diagonal line shown in

FIG. 15. The partial overlapping of pixels has a similar visual result to an anti-aliasing filter on a conventional non-overlapping image.

1. An imaging screen having an array of light sensitive pixel devices arranged in a first lattice pattern; and an optical layer having an array of light guides, each light guide having a input end and an output end, the input ends being arranged in a second lattice pattern, and the output ends being arranged in the first lattice pattern and directed towards the pixel devices whereby the light guides guide light from their input ends to their output ends and onto the pixel devices.

2. An imaging screen according to claim 1 wherein the light guides have light reflecting walls which each guide light towards a respective pixel device.

3. An imaging screen according to claim 1 wherein the first or second lattice pattern is a hexagonal lattice pattern.

4. An imaging screen according to claim 3 wherein one of the lattice patterns is a hexagonal lattice pattern and the other lattice pattern is a rectangular lattice pattern.

5. An imaging screen according to claim 1 wherein the first end of each light guide has a first shape, and the second end of each light guide has a second shape.

6. An imaging screen according to claim 5 wherein the first or second shape is substantially hexagonal.

7. An imaging screen according to claim 6 wherein one of the shapes is substantially hexagonal and the other shape is substantially rectangular.

8. An imaging screen according to claim 1 wherein the optical layer physically engages the pixel devices.

9. An imaging device having a screen according to claim 1; and an output interface for receiving image data from the light sensitive pixel devices.

10. An imaging device according to claim 9 having a resampler programmed to:
receive the image data from the output interface, resample the image data into a format compatible with a different lattice pattern, and output the resampled image data.

11. An imaging device according to claim 10, wherein the device is hand-held and portable.

12. A display device including:
(a) a display screen including an array of pixel devices arranged in a first lattice pattern; and an optical layer having an array of light guides, each light guide having a input end and an output end, the output ends being arranged in a second lattice pattern, and the input ends being arranged in the first lattice pattern and directed towards the pixel devices whereby the light guides guide light from the pixel devices from their input ends to their output ends;
(b) a screen drive for driving the pixel devices in accordance with a set of image data; and
(c) a resampler programmed to receive image data in a format compatible with the first lattice pattern, resample the image data into a format compatible with the second lattice pattern and output the resampled image data to the screen drive.
